(19) United States
(12) Patent Application Publication
(10) Pub. No.: US 2016/0350686 A1
(43) Pub. Date: Dec. 1, 2016

(54) IMPLEMENTING WORKFLOW BASED ON SOCIAL NETWORK NODES

(71) Applicant: International Business Machines Corporation, Armonk, NY (US)

(72) Inventors: Ana Paula Appel, Sao Paulo (BR); Rogerio A. de Paula, Sao Paulo (BR); Claudio S. Pinhanez, Sao Paulo (BR); Vagner F. de Santana, Sao Paulo (BR)

(21) Appl. No.: 14/747,273

(22) Filed: Jun. 23, 2015

Related U.S. Application Data
(63) Continuation of application No. 14/724,998, filed on May 29, 2015.

(51) Int. Cl. G06Q 10/06; H04L 12/24; G06Q 50/00; H04L 29/08

(52) U.S. Cl. CPC G06Q 10/06311; H04L 67/12; H04L 41/22; G06Q 50/01

(57) ABSTRACT

A work process may be implemented based on social and enterprise networks. Candidate workers involved in the work process may be identified. A work-social network may be generated by merging social network information and work network information associated with the candidate workers. An overlap between the work-social network and the work process may be maximized or minimized by ranking the nodes representing the candidate workers in the work-social network. A set of top ranked nodes may be output as a list of selected workers to perform the work process.

### FIELD

The present application relates generally to computers and computer applications, and more particularly to implementing workflow based on social network nodes.

### BACKGROUND

A workflow such as a business process or business method is a collection of related, structured activities or tasks that produce a specific service or product (serve a particular goal), for example, for a particular customer or customers. The present disclosure describes how to automatically assign tasks in the workflow to workers based on a social network involving workers in the workflow and the people that created a request for work.

### BRIEF SUMMARY

A method and system of implementing a work process may be provided. The method, in one aspect, may comprise starting a work process in an enterprise based on a request from a process requester. The method may also include identifying, by one or more processors, candidate workers involved in the work process. The method may further include obtaining social network information associated with the candidate workers from one or more social network databases. The method may also include obtaining work network information associated with the candidate workers from one or more work network databases. The method may further include generating a work-social network by merging the social network information and the work network information. The method may also include determining whether to maximize an overlap between the work-social network and the work process. Responsive to determining that the overlap is to be maximized, the method may also include ranking the nodes representing the candidate workers in the work-social network that are closest. Responsive to determining that the overlap is not to be maximized, the method may also include ranking the nodes representing the candidate workers in the work-social network that are farthest. The method may further include selecting top ranked nodes that meet a workload threshold. The method may also include outputting the top ranked nodes as a list of selected workers to perform the work process.

A system for implementing a workflow process, in one aspect, may comprise one or more hardware processor. One or more workflow processes may execute on the one or more hardware processors. The workflow process may have one or more tasks, each task having one or more task attributes. One or more social network databases may describe one or more social networks that define individuals with individual attributes connected by relationships in a network. One or more work network databases describe one or more work networks that define individuals with individual attributes connected by relationships in an enterprise network. A correlator may correlate one or more of the tasks to one or more of the individuals in the social network and work network by matching the task attributes with the individual attributes, and based on whether to maximize or minimize an overlap between the individuals involved in the one or more workflow processes and a combination of the social network and the work network.

A computer readable storage medium storing a program of instructions executable by a machine to perform one or more methods described herein also may be provided.

Further features as well as the structure and operation of various embodiments are described in detail below with reference to the accompanying drawings. In the drawings, like reference numbers indicate identical or functionally similar elements.

### BRIEF DESCRIPTION OF THE DRAWINGS

FIG. 1 is a diagram illustrating components of a system for implementing a workflow in one embodiment of the present disclosure.

FIG. 2 is a diagram illustrating a work-social network involving process requesters and workers involved in a business process in one embodiment of the present disclosure.

FIG. 3 is a diagram illustrating a business process and workers selected for work process in one embodiment of the present disclosure.

FIG. 4 is a diagram illustrating an example of a business process in one embodiment of the present disclosure.

FIG. 5 is a diagram illustrating an example of a user's social network in one embodiment of the present disclosure.

FIG. 6 is a diagram illustrating a combined network of an example user's social network, work network of workers involved in an example business process and the social network of all workers involved in the business process in one embodiment of the present disclosure.

FIG. 7 is a flow diagram illustrating a method of implementing a work process based on social and work network nodes in one embodiment of the present disclosure.

FIG. 8 illustrates a schematic of an example computer or processing system that may implement a system in one embodiment of the present disclosure.

### DETAILED DESCRIPTION

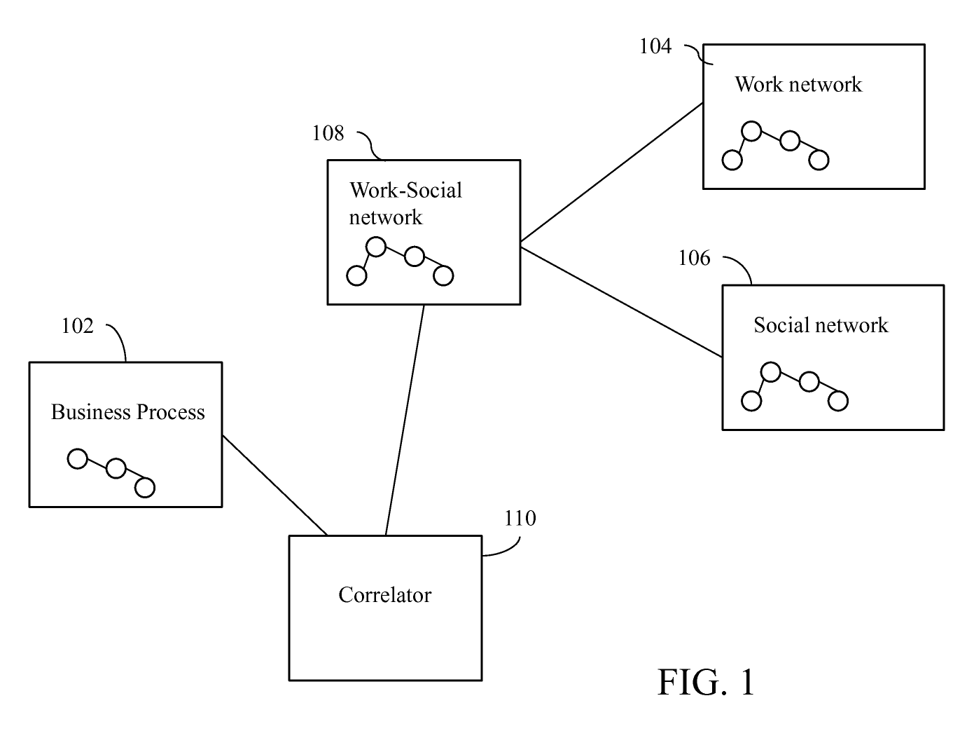

FIG. 1 is a diagram illustrating components of a system for implementing a workflow in one embodiment of the present disclosure. A business process network contains one or more connected business processes. A business process 102 contains one or more tasks, which are steps of a business process. Each task may be performed by at least one person. Process requester is the person who starts/triggers a business process. A Work/Enterprise network (WN) 104 represents how people inside the enterprise performing the business process know each other. Social network (SN) 106 represents how people are socially connected outside the enterprise. Work-social network (WSN) 108 represents the union between work/enterprise network 104 and social network 106. An embodiment of a methodology in the present disclosure maximizes or minimizes the intersection between process requester's work-social network 108 and business process network (e.g., 102). Social network and work/enterprise network (or information associated with the networks) may be stored in a database. Social network and work/enterprise network applications allow users of the respective networks to communicate among one another online, e.g., by activities such as posting, messaging, sharing, commenting on, and/or others, for example, via a user interface or a graphical user interface, e.g., presented on a display device.

A computer-implemented system may automatically determine the choice of these people to a task in a business process and often one or more persons from the same department may execute the task. A business process 102 can take different amount of time to execute, e.g., depending on the choice of the people who perform the tasks in the business process.

A WSN 108 may have different formats, with hierarchy of social network nodes and kinship or relationship between the nodes. A WSN can provide the information to select people to perform tasks. For example, assigning tasks in a business process 102 to people who know one another (e.g., as identified in a social network) may facilitate and speed up the execution of task. As another example, information in the WSN 108 can be used to prevent assigning tasks to people connected in a WSN, for example, to avoid possible conflicts of interest.

An embodiment of the present disclosure takes into account the enterprise's (WN) 104 and social network (SN) 106 in the task assignment phase. For example, based on a user's and worker's enterprise's network and social network, a task may be assigned (in the case of increasing the overlap between social network and business process network) or prevented (in the case of avoiding overlap between the networks). An embodiment of the present disclosure may maximize or minimize the intersection between a business process and enterprise and social networks of people involved.

A methodology and/or system of the present disclosure in one embodiment may take as input a business process, work and social networks of a requester and work and social networks of people involved in the business process. In one embodiment, the work and social networks from people involved in business process are combined with the work and social network from the business process requester creating WS network. The people in business process refer to people who are candidates for working on the tasks in the business process.

An embodiment of the methodology and/or system of the present disclosure may find people in the combined network, e.g., out of those candidates for working on the process, those that are closest in the combined network. In addition, people considered in the business process are chosen considering how they are connected, e.g., directly, as close friends, indirectly via another person in the network.

If the requester is looking to assign tasks in a way to avoid possible conflicts of interest, an embodiment of the methodology of the present disclosure considers choosing the farthest people in the requester's social network or who are not in the social network at all. In addition, people considered in the process chain are chosen considering the farthest or unconnected people.

The methodology in one embodiment also considers the current workload of a person in the task assignment process.

In one aspect, one or more workflow or work processes (business processes) may be executing on one or more processing devices. The one or more processing devices may include one or more of computers, smartphones, tablets and other computational devices. The one or more workflow processes have one or more tasks and each task has one or more task attributes. One or more social network databases describe one or more social networks that define individuals with individual attributes connected by relationships in a network. For example, a node in a network of connected nodes represents an individual, and the network of connected nodes make up a social network. Each node has a profile that includes the individual attributes. One or more work network databases describe one or more work networks that define individuals with individual attributes connected by relationships in an enterprise network. A correlator 110 may correlate one or more of the tasks to one or more of the nodes representing individuals in the social network and work network by matching task attributes with individual attributes, and based on whether to maximize or minimize an overlap between the individuals involved in the one or more workflow processes and a combination of the social network and the work network.

The task attributes include any one or more of the following: an individual name, an area of expertise, a task function, a role in the enterprise, a workload. The social network is used to locate an individual to perform the task. Substitute individuals from the social network that qualify to perform the task may be provided. In another aspect, an individual may be excluded from performing the task based on the connections in work-social network with a process requester. For instance, the social network is used to locate an individual to not perform the task so avoid conflict of interest.

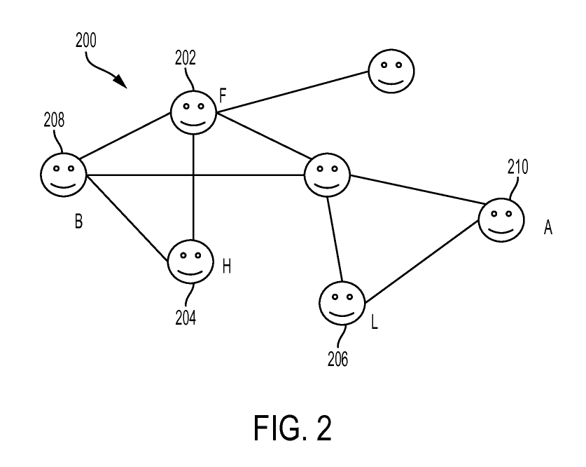

FIG. 2 is a diagram illustrating a WSN involving process requesters (A and B) and people involved in the business process (F, H, and L). For example, business process shows, for example, in its attributes, that people at 202, 204 and 206 (F, H and L, respectively) are involved in performing tasks of the business process. A work social network (200) of requesters at 208 (B) and 210 (A) show the connections among the requesters and the people involved in the business process. The WSN 200 shows that the requester A (210) is connected directly with L (206); the requester B (208) is directly connected with F (202) and H (204).

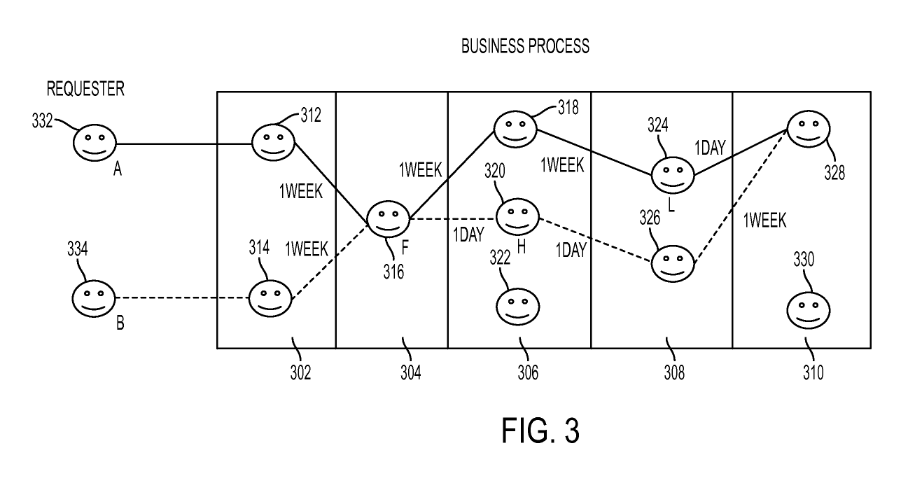

FIG. 3 is a diagram illustrating a business process and people selected for requests triggered by requester A and requester B, considering that A is connected with L and that B is connected with F and H. For example, a business process may involve a plurality of tasks 302, 304, 306, 308 and 310. People or workers at 312, 314 may be able to perform the task at 302; people or worker at 316 may be able to perform the task at 304; people or workers at 318, 320, 322 may be able to perform the task at 306; people or workers at 324, 326 may be able to perform the task at 308; and people or workers at 328, 320 may be able to perform the task at 310. Based on the information from WSN (e.g., shown in FIG. 2), people represented by the nodes connected by the solid line shown in FIG. 3 may be selected to perform the tasks involved in the business process requested by requester A 332. Similarly, people represented by the nodes connected by the dashed line shown in FIG. 3 may be selected to perform the tasks involved in the business process requested by requester B 334. In one embodiment, a graphical user interface may be provided that displays or presents the graphics shown in FIG. 3. The graphical user interface may include an editing capability that allows a user to move or adjust the connecting lines to connect to another node that represents another worker for changing or adjusting who should be performing a given task.

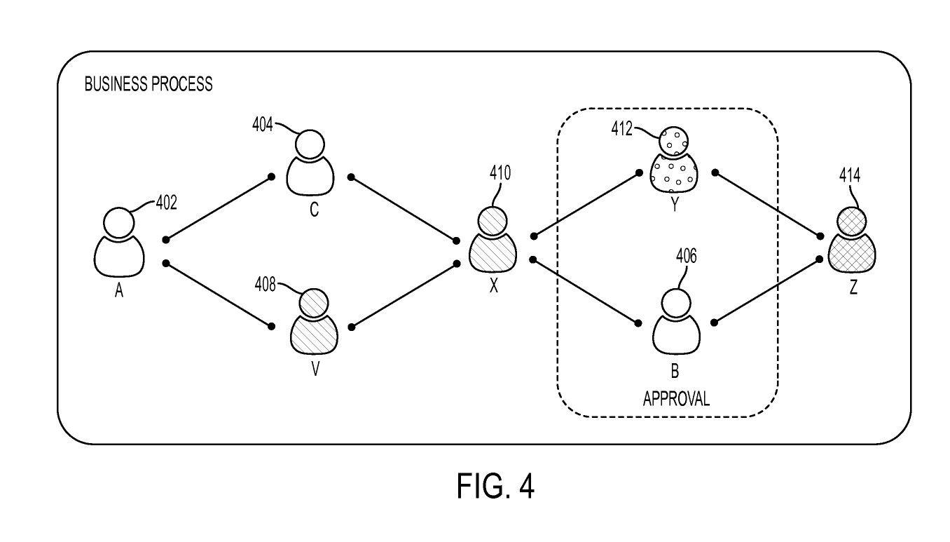

FIG. 4 is a diagram illustrating an example of a business process in which A is the requester and a key task in the business process involves the approval of the A's request. Consider that the nodes that have the same hatching or shades in the diagram (e.g., nodes 402, 404, 406 have the same shading, and nodes 408, 410 have the same shading), are linked in their respective social networks. In this example, if the goal is to maximize the overlap, the path A-C-X-B-Z (402-404-410-406-414) would be selected. If the goal is to minimize the overlap between the networks, the path A-V-X-Y-Z (402-408-410-412-414) would be selected.

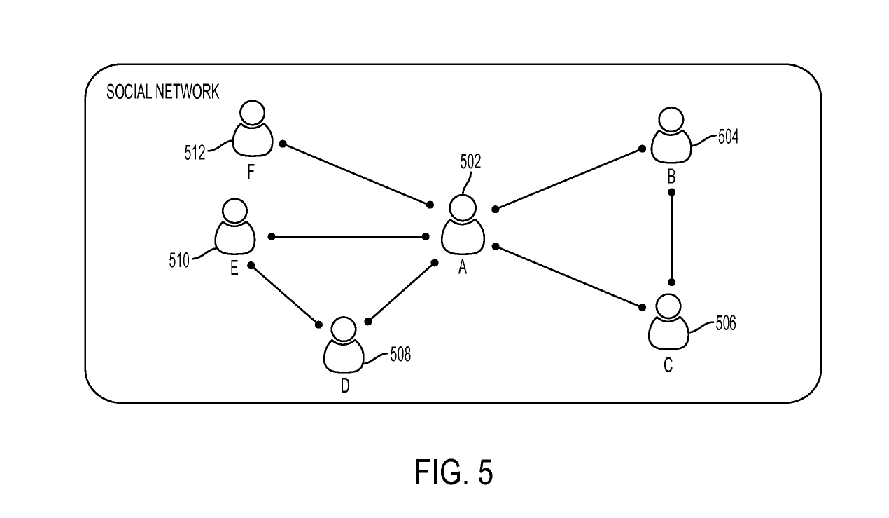

FIG. 5 is a diagram illustrating an example of a user's, e.g., A's social network in one embodiment of the present disclosure. For instance, user A 502 has direct relationship in user A's social network to users B 504, C 506, D 508, E 510 and F 512.

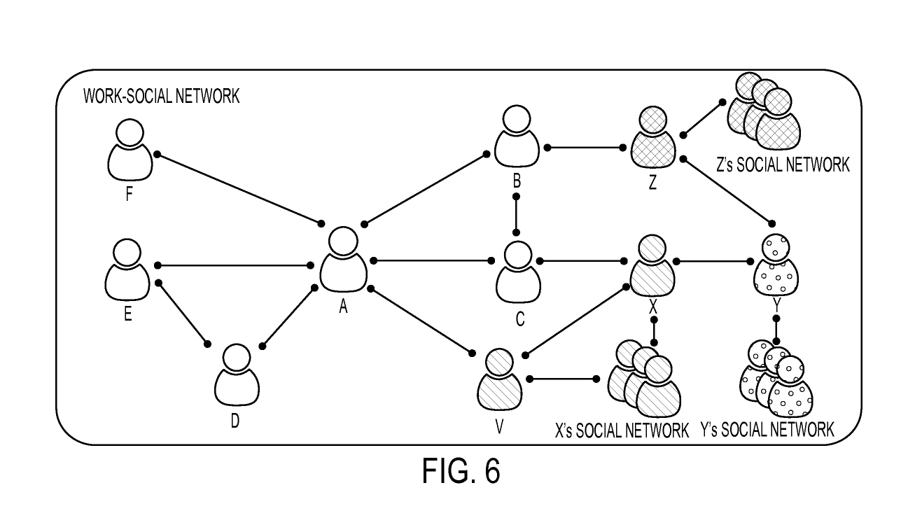

FIG. 6 is a diagram illustrating a combined network of an example user's social network, work network of people involved in an example business process and all the social network of all people involved in the business process. For instance, the diagram shows the union of A's social network (e.g., shown in FIG. 5), the work network of people involved in the business process (e.g., shown in the FIG. 4), and all the social network of all people involved in the business process. The nodes with same shading or hatching represent the same social network. Nodes from different social network may be connected via a work network of people involved in the business process.

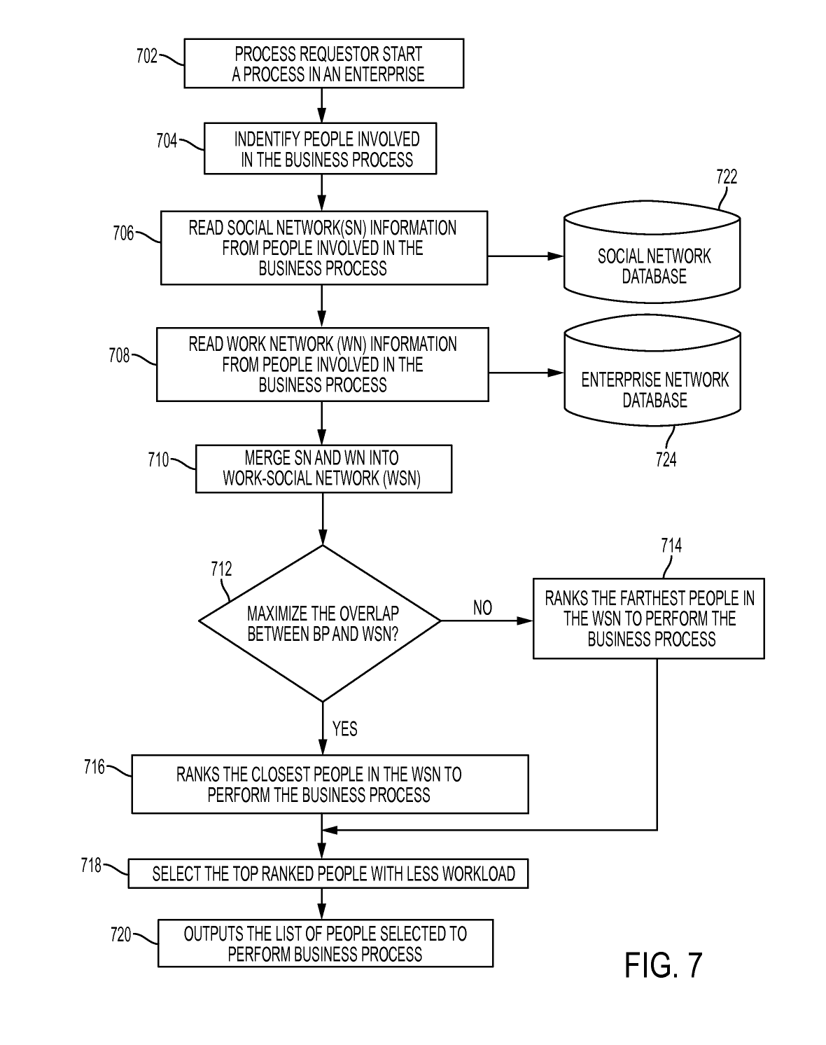

FIG. 7 is a flow diagram illustrating a method of implementing a workflow based on social network nodes in one embodiment of the present disclosure. At 702, a process requester starts a work process, e.g., a business process, in an enterprise. As described above, the process may include a plurality of tasks, and the tasks identify (e.g., by attributes) candidate workers or people able to work of the tasks. The information associated with the process, e.g., the tasks involved in the process, the attributes associated with the tasks, e.g., candidate workers that can perform the task, and other information may be stored in a database of business processes.

At 704, people involved in the process (e.g., work or business process) are identified. For example, information associated with the tasks of the process, the people involved in the task (e.g., candidate workers who may be able to perform one or more of the tasks) may be retrieved from a database of business processes.

At 706, social network information associated with the candidate workers of the tasks in the process is read or retrieved. For example, a social network database 722 may store the social network information associated with those people or workers involved in the business process. The retrieved social network information in one embodiment may include a network of connected nodes representing a worker's social relationship, e.g., for each of the candidate workers.

At 708, work network information associated with the candidate workers of the tasks in the process is read or retrieved. For example, an enterprise network database 724 may store the work network information associated with those people or workers involved in the business process. The retrieved work network information in one embodiment may include a network of connected nodes representing a worker's business relationship, e.g., for each of the candidate workers.

At 710, the social network information and the work network information retrieved at 706 and 708 are merged to generate a work-social network (WSN). This WSN may be stored in memory or as a database of WSNs. The merging, for example, may eliminate any duplicate nodes, but preserves the relationships or connections between the nodes.

At 712, it is determined whether to maximize the overlap between the business process and the work-social network. Whether to maximize or minimize the overlap, for example, may be input by the requester, for example, via a graphical user interface. In another aspect, whether to maximize or minimize may be specified as a parameter at the time the requester starts the process, e.g., at 702. Maximizing the overlap (i.e., nodes and nodes' connections appearing in both networks), for instance, tries to select those nodes representing people that are connected in the business process, and also connected in the work-social network.

If it is determined that the overlap is not to be maximized (e.g., the overlap is being minimized), at 714, the farthest nodes from the requester representing people or candidate workers in the WSN are ranked to perform the tasks of the business process. Nearness (closeness) or farness of nodes in one embodiment may be determined based on the number of connections or intermediate nodes that exist in the path between two nodes.

If at 712, if it is determined to maximize the overlap, the logic proceeds to 716. At 716, the closest nodes to the requester in the WSN are ranked to perform the business process.

At 718, the top ranked people with less workload may be selected. For instance, whether a worker has less workload or not may be determined based on a predetermined threshold of workload. Hence, for example, a worker may be top ranked but the worker's workload may exceed the workload threshold. In that case, the logic at 718 may select the next ranked worker who has workload that does not exceed the workload threshold. In one aspect, the workload threshold is a configurable parameter.

At 720, the list of people or workers selected to perform the business process are output. In one embodiment, the output may be presented on a graphical user interface, as a graphical display, for example, as shown in FIG. 3. In this way, the methodology and/or system of the present disclosure allow a user to understand or view the selected and not selected workers involved in the business process.

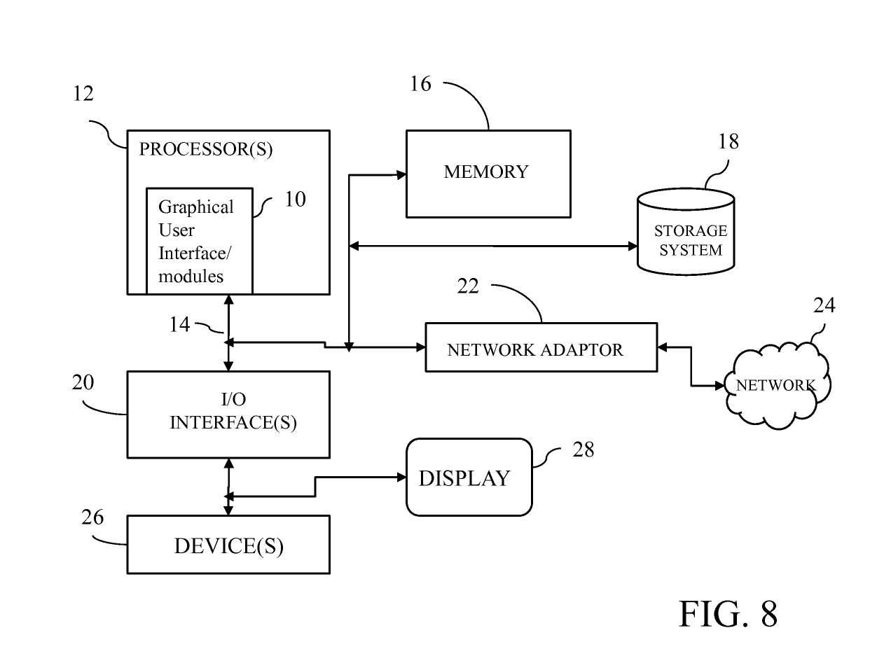

FIG. 8 illustrates a schematic of an example computer or processing system that may implement a system in one embodiment of the present disclosure. The computer system is only one example of a suitable processing system and is not intended to suggest any limitation as to the scope of use or functionality of embodiments of the methodology described herein. The processing system shown may be operational with numerous other general purpose or special purpose computing system environments or configurations. Examples of well-known computing systems, environments, and/or configurations that may be suitable for use with the processing system shown in FIG. 7 may include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

The computer system may be described in the general context of computer system executable instructions, such as program modules, being executed by a computer system. Generally, program modules may include routines, programs, objects, components, logic, data structures, and so on that perform particular tasks or implement particular abstract data types. The computer system may be practiced in distributed cloud computing environments where tasks are performed by remote processing devices that are linked through a communications network. In a distributed cloud computing environment, program modules may be located in both local and remote computer system storage media including memory storage devices.

The components of computer system may include, but are not limited to, one or more processors or processing units 12, a system memory 16, and a bus 14 that couples various system components including system memory 16 to processor 12. The processor 12 may include a module 10 that performs the methods described herein. The module 10 may be programmed into the integrated circuits of the processor 12, or loaded from memory 16, storage device 18, or network 24 or combinations thereof.

Bus 14 may represent one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system may include a variety of computer system readable media. Such media may be any available media that is accessible by computer system, and it may include both volatile and non-volatile media, removable and non-removable media.

System memory 16 can include computer system readable media in the form of volatile memory, such as random access memory (RAM) and/or cache memory or others. Computer system may further include other removable/non-removable, volatile/non-volatile computer system storage media. By way of example only, storage system 18 can be provided for reading from and writing to a non-removable, non-volatile magnetic media (e.g., a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 14 by one or more data media interfaces.

Computer system may also communicate with one or more external devices 26 such as a keyboard, a pointing device, a display 28, etc.; one or more devices that enable a user to interact with computer system; and/or any devices (e.g., network card, modem, etc.) that enable computer system to communicate with one or more other computing devices. Such communication can occur via Input/Output (I/O) interfaces 20.

Still yet, computer system can communicate with one or more networks 24 such as a local area network (LAN), a general wide area network (WAN), and/or a public network (e.g., the Internet) via network adapter 22. As depicted, network adapter 22 communicates with the other components of computer system via bus 14. It should be understood that although not shown, other hardware and/or software components could be used in conjunction with computer system. Examples include, but are not limited to: microcode, device drivers, redundant processing units, external disk drive arrays, RAID systems, tape drives, and data archival storage systems, etc.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements, if any, in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

We claim:

1. A method of implementing a work process, comprising:
starting a work process in an enterprise based on a request from a process requester;
identifying, by one or more processors, candidate workers involved in the work process;
obtaining social network information associated with the candidate workers from one or more social network databases;
obtaining work network information associated with the candidate workers from one or more work network databases;
generating a work-social network by merging the social network information and the work network information;
determining whether to maximize an overlap between the work-social network and the work process;
responsive to determining that the overlap is to be maximized, ranking the nodes representing the candidate workers in the work-social network that are closest;
responsive to determining that the overlap is not to be maximized, ranking the nodes representing the candidate workers in the work-social network that are farthest;
selecting top ranked nodes that meet a workload threshold; and
outputting the top ranked nodes as a list of selected workers to perform the work process.

2. The method of claim 1, wherein the work network information comprises a network of connected nodes representing the candidate workers' relationships in the enterprise.

3. The method of claim 1, wherein the social network information comprises a network of connected nodes representing the candidate workers' social relationships outside of the enterprise.

4. The method of claim 1, wherein the one or more work network databases and the one or more social network databases are stored in a storage device.

5. The method of claim 1, wherein whether to maximize the overlap is determined based on an input by the process requester.

6. The method of claim 1, wherein the outputting further comprises presenting a graphical user interface display of the selected workers as connected nodes.

7. The method of claim 1, wherein the workload threshold is configurable.
